(19) United States
(12) Patent Application Publication
(10) Pub. No.: US 2003/0112908 A1
(43) Pub. Date: Jun. 19, 2003

(54) Multi-interpolated data recovery with a relative low sampling rate

(76) Inventor: William Mar, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,522

(22) Filed: Jul. 24, 2002

(30) Foreign Application Priority Data
Dec. 19, 2001 (TW) 090131559

(51) Int. Cl. H04L 7/00

(52) U.S. Cl. 375/355; 375/364; 375/365

(57) ABSTRACT

A method and related circuit for recovering a digital signal can operate with a sampling frequency less than a data frequency. The circuit includes a plurality of interpolators for generating an output signal. The output signal is used by a computation module to generate a plurality of control words. The control words are used by the interpolators to perform weighted interpolation functions to precisely generate the output signal. A data circuit can then extract the original input signal digital information from the output signal.

### BACKGROUND OF INVENTION

1. Field of the Invention

The present invention relates in general to a data recovery method and the related circuits, and more particularly, to a data recovery method and related circuit having multiple interpolators that makes a sampling rate lower than a data rate possible.

2. Description of the Prior Art

At present, with the development of advanced electronics technology, propagations and interchanges of information are done very quickly through digital signal transmissions. For instance, the data in a digital versatile disc (DVD) can be read by a DVD drive with the data processing being done by way of digital signals. In fact, signal communications between different components in a computer system are all facilitated by digital signals through data buses. In addition, the information interchange between computer systems everywhere by computer networks and the Internet is also handled by digital signals.

Referring to a continuous waveform diagram shown in FIG. 1, having time along the abscissa, an original analog signal 10 is shown acting as a carrier for digital data 14. The original signal 10 could be the signal from a DVD optical pickup, from a data bus, or any other electronic signal in a communication or Internet system. With the aid of a data clock 12, the amplitude of original signal 10 is modulated to carry the information of the digital data 14. The data clock 12 comprises a plurality of data periods having a predetermined time length T0. Each data period corresponds to one bit in the digital data 14, and the bit level is determined by the corresponding amplitude of the original signal 10. Referring to FIG. 1, at specific times determined by the rising edges of the pulses of the data clock 12, such as t1, t2, t3, etc, the corresponding digital data 14 is determined by whether the amplitude of the original signal 10 is higher than a predetermined standard level L0, which is usually a zero level.

For instance, as the amplitude of original signal 10 is higher than the standard level L0 at time t1, the corresponding bit level D1 of the digital data 14 is “1”. The situation is the same for the bit level D2, also having a value of “1”, at time t2. However, as the amplitude of original signal 10 is lower than the standard level L0 at times t6 and t8, the corresponding bit levels D6 and D8 of the digital data 14 are “0”. Consequently, with the aid of the data clock 12, the amplitude of original signal 10 is corresponded to the bit levels of digital data 14.

Actually, there are situations when original signal is the only signal that is analyzed. For example, when the original signal comes from the optical pickup in a compact disk drive there is no data clock that can be readily used. The same situation occurs in communication systems, in which the only signal for transmission is the original signal. For this reason, a data recovery circuit must be utilized to extract the digital data from the original signal. A circuit block diagram of a prior art data recovery circuit 20 is shown in FIG. 2. The prior art data recovery circuit 20 comprises a sampler 22, an interpolator 24, a computation module 26, and a data circuit 28. The data recovery circuit 20 is a digital circuit. The sampler 22 is utilized to convert an analog input signal 16, which is the same type of signal as the original signal 10 in FIG. 1, into a discrete sampling signal 23, with a sampling frequency determined by a sampling clock 18. Because the sampling clock 18 is not synchronized with a data clock of the input signal 16, the interpolator 24 is used to convert the sampling signal 23 into an output signal 25 through a weighted interpolation process with the aid of the data clock corresponding to the input signal 16. The output signal 25, a signal recovered from the input signal 16, is then synchronized with the data clock corresponding to the input signal 16. Thereafter, signal processing by the data circuit 28, which can be a comparator, a clipper, or similar, is able to recover the digital data from the input signal 16. The weighted interpolation process of the interpolator 24 is controlled by a control word 30 that is generated by a computation module 26 via feedback from the output signal 25.

For a better understanding of the operation of the prior art data recovery circuit 20, waveform clock diagrams of the related signals are shown in FIG. 3, which has time along the abscissa. The waveform diagrams, from top to bottom, correspond to the data clock 12, the input signal 16, and the sampling clock 18. As aforementioned, the data recovery circuit 20 must recover the digital data directly from input signal 16 without the aid of the original data clock 12. The waveform of the input signal 16 is shown in FIG. 3 as a dotted curved line. The sampling clock 18 in FIG. 3 is shown to comprise a plurality of sampling periods with a predetermined period Tps, which corresponds to a sampling frequency of 1/Tps. All samples are related to sampling times, ta1, ta2, ta3, etc. Using the triggering control of sampling clock 18, sampler 22 is able to convert the input signal 16 into the sampling signal 23, which is a discrete time signal as shown in FIG. 3. However, without the use of the data clock 12 as a reference signal in data recovery circuit 20, the sampling clock 18 is not actually synchronized with data clock 12. Accordingly, the major function of interpolator 24 is to shift the sampling signal 23 to become the output signal 25, which is still a discrete time signal but is synchronized with data clock 12, through the weighted interpolation process. Taking advantage of the output signal 25, the data circuit 28 is able to extract the digital data from the input signal 16.

In order to recover the output signal 25 from the sampling signal 23, interpolator 24 uses the control word 30 as a parameter to control the process of interpolation. In the prior art, each sampling period has a control word that is used to estimate the phase difference, which is actually equivalent to a time difference, between the related sampling period and a nearest data period. Although the data recovery circuit 20 cannot take advantage of the original data clock 12, the computation module 26 is able to access the output signal 25 as a feedback control signal. An estimate of the corresponding phase difference between the sampling clock 18 and the data clock 12 and a control word corresponding to each sampling period, can be acquired with the aid of phase error detection in conjunction with over-sampling rate (OSR) adjustment. Other well-known prior art processes are used and, for the sake of clarity, will not be repeated here. After generation of the control words 30 by the computation module 26, a control word mp1, corresponding to a sampling period at time ta1, is utilized to estimate the phase difference between the sampling period and a data period at time t1. Similarly, a control word mp2 is utilized to estimate the phase difference between a sampling period at time ta2 and a data period at time t2. However, at time ta4, the data period nearest to the corresponding sampling period is located at time t3, so the control word mp4 is utilized to estimate the phase difference between a sampling period at time ta4 and a data period at time t3.

After the control words 30 from the computation module 26 are input to the interpolator 24, the interpolator 24 is able to generate output signal 25 by a weighted interpolation process performed on the sampling signal 23. For instance, the amplitude of output signal at time t1 can be calculated based on the control word mp1 at time ta1 by the following weighted interpolation formula:

$$y ( t1 ) - {\sum }_{n = 1}^{N2} x ( t a 1 - n Tps ) w ( mp1 + nTps )$$

Wherein y(t1) is the amplitude of the output signal 25 at time t1, w(˜) is a preset weighting function such as a sinc function, which is defined as sinc(x)=sin(nx)/(nx), and x(˜) is the amplitude of the sampling signal 23. N1 and N2 are integers that define the upper and lower limits of the summation. In other words, the output signal at time t1 can be calculated by the summation of the product of the sampling signal 23 at time ta1, that is x(ta1), and the weighting function w(mp1), and the product of the sampling signal 23 at time ta2, that is x(ta1 +Tps), and the weighting function w (mp1−Tps), and the product of the sampling signal 23 at time ta3, that is x (ta1 +2Tps), and the weighting function w(mp1−2Tps), and so on. Similarly, the output signal at time t2 can be calculated by the same procedure with ta1 and mp1 replaced by ta2 and mp2, respectively. Based on the abovementioned process, the interpolator 24 is able to generate the output signal 25 from the sampling signal 23.

The prior art data recovery circuit 20 can be realized with digital circuits. However, in the prior art, one sampling period can only be used to estimate a control word, which is used to estimate the phase difference between a sampling period and the nearest data period. Consequently, the duration Tps of one sampling period must not be longer than the duration T0 of one data period. If the duration Tps of one sampling period is longer than the duration T0 of one data period, one sampling period will correspond to more than one data period. Since one control word can only estimate the amplitude of the output signal 25 corresponding to one data period, the other data periods will have no corresponding control words to generate output signal 25. Thus, the interpolator 24 of the prior art data recovery circuit 20 is not able to recover the output signal 25 from every corresponding data period completely. Consequently, the sampling period must not be longer than the data period. In other words, the sampling frequency of the sampling clock must be higher than the frequency of the data clock. Because of the demand for high-speed operation, access, and transmission of digital data, the data period is getting shorter, and the frequency of the data clock is getting higher. Accordingly, an even higher sampling frequency is required. As a result, the prior data recovery circuit suffers the side effects of high frequency operation such as electromagnetic interference and other related parasitic effects. Another disadvantage of the prior art technology comes from the complex circuit design for high frequency circuits, which results in higher cost for both circuit design and production.

### SUMMARY OF INVENTION

It is therefore a primary objective of the claimed invention to provide a data recovery circuit with a sampling frequency lower than a data clock frequency to solve the prior art problems.

According to the claimed invention, the data recovery method, for recovering digital data from a corresponding input signal comprises first selecting a sampling clock with a predetermined sampling frequency, the sampling clock comprising a plurality of sampling periods. Then, calculating at least a control word during each sampling period, each control word being used for estimating a phase difference between the sampling period and the corresponding data period. And finally, calculating original amplitude of the input signal during each data period of the data clock according to the corresponding control words and amplitude of the input signal during each sampling period of the sampling clock for recovering the digital data.

According to one embodiment of the claimed invention, the data recovery circuit comprises a sampler, a first interpolator, a second interpolator, a computation module, and a data buffer unit. The computation module further comprises a first computation unit and a second computation unit.

It is an advantage of the claimed invention that the data recovery circuit is capable of extracting an output signal precisely, without requiring a sampling frequency higher than a data clock frequency and the related costly high frequency components.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows waveform diagrams of an original signal, a data clock, and a digital data signal according of the prior art.

FIG. 2 is a block diagram of a prior art data recovery circuit.

FIG. 3 shows waveform diagrams of a data clock, with the input signal and the sampling clock shown in FIG. 2.

FIG. 4 is a frequency spectrum plot of related signals in a data recovery process according to the present invention.

FIG. 5 is a functional block diagram of a data recovery circuit according to a preferred embodiment of the present invention.

FIG. 6 shows waveform diagrams of a data clock, an input signal, a sampling signal, an output signal, and a sampling clock according to the present invention.

FIG. 7 is a more detailed block diagram of the data buffer unit of FIG. 5 of the present invention.

### DETAILED DESCRIPTION

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

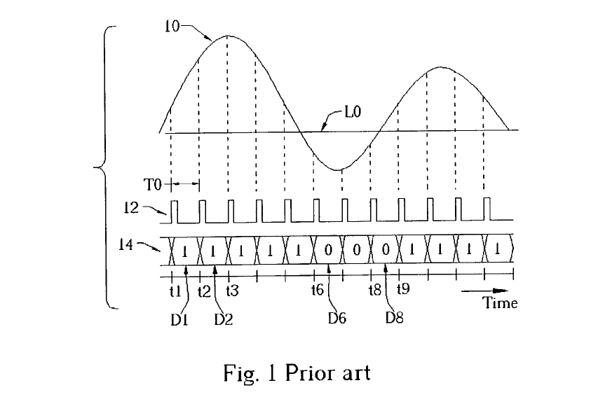

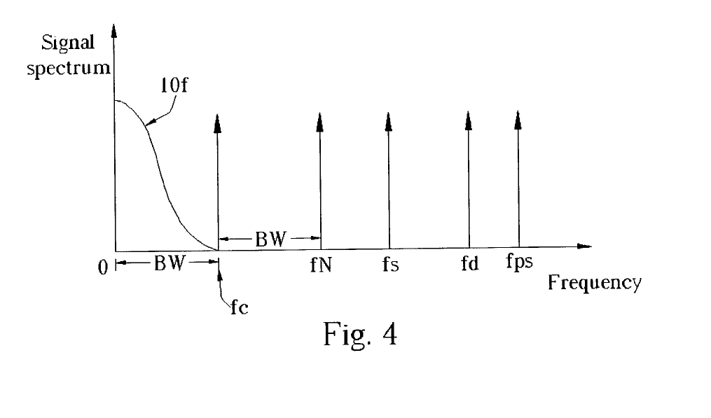

A spectrum plot of related signals in a data recovery process is shown in FIG. 4, with a frequency scale along the abscissa and a signal scale along the ordinate. The spectrum 10f of the waveform of an original signal, a digital data carrier, is shown to have a bandwidth of BW and have a highest frequency of fc. The frequency of a data clock corresponding to the digital data of the original signal is fd. As is shown in FIG.1, after the coding modulation of the original signal, the rate of change of an original signal waveform 10 is slower than the rate of change of a data clock 12. For instance, as the data clock 12 experiences one period, the waveform of original signal 10 only increases leisurely from time t1 to t2. This means that the bandwidth BW of the original signal is much lower than the frequency fd of the corresponding data period. According to the Nyquist theorem, also known as the sampling theorem, if a first signal is to be recovered by the sampling of a second signal, the sampling frequency must at least higher than twice the bandwidth of the second signal. For this reason, as illustrated by FIG. 4, the frequency fN, which is the lowest sampling frequency according to the Nyquist theorem, is twice the frequency fc. In practical application, the frequency fN is still lower than the frequency fd of the corresponding data period. In the prior art, the sampling frequency of the sampling clock in a sampler must be higher than the frequency fd of the corresponding data period. The frequency fps in FIG. 4 is the sampling frequency being used in the prior art. However, if a output signal is to be recovered by a interpolation process with the aid of a sampling clock, the sampling frequency is only required to be higher than the frequency fN predicted by the Nyquist theorem and not the frequency fd of the corresponding data period. Taking the advantage of the Nyquist theorem, the sampling frequency fs of the present invention, having a sampling period of Ts=1/fs, is preset to be a frequency between fN and fd. A detailed description of how this is achieved will now be given.

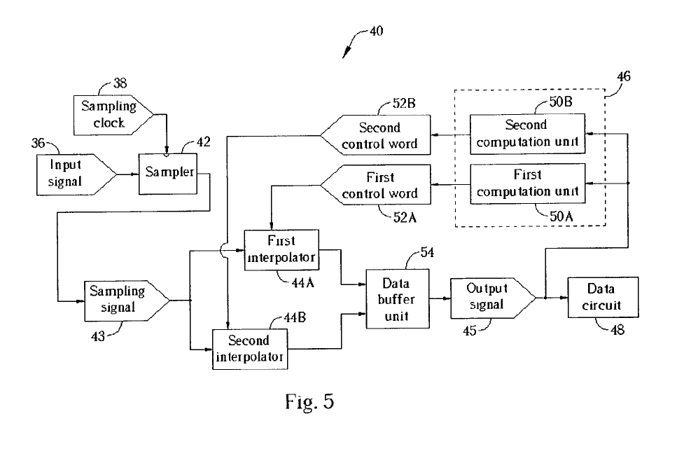

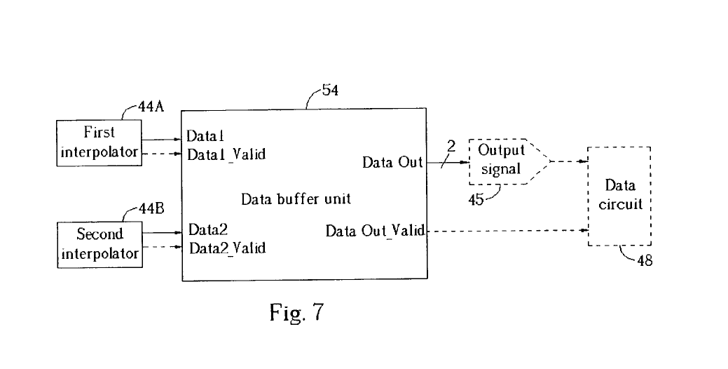

A functional block diagram of a data recovery circuit 40, in accordance with a preferred embodiment of the present invention, is shown in FIG. 5. The function of the data recovery circuit 40 is to recover the digital data in an input signal 36 without the aid of related data clock. The input signal 36 is outputted from any conventional optical disk storage devices, such as compact disk (CD) players, CD-ROM, digital versatile disc (DVD) devices or the like or even from any conventional magnetic disk storage device. The data recovery circuit 40 comprises a sampler 42, a first interpolator 44A, a second interpolator 44B, a data circuit 48, a computation module 46, and a data buffer unit 54. As shown in FIG. 5, the computation module 46 comprises a first computation unit 50A and a second computation unit SOB. After the input signal 36 is input to the data recovery circuit 40, a sampling process performed by the sampler 42 converts the input signal 36 to a sampling signal 43, which is a sequence of discrete time sample values. The sampling frequency of the sampler 42 is determined by a sampling clock 38. The sampling signal 43 is processed by the first interpolator 44A and the second interpolator 44B using a weighted interpolation process to generate interpolated data for the two inputs of data buffer unit 54. Data buffer unit 54 integrates the interpolation results from both the first interpolator 44A and the second interpolator 44B and generates an output signal 45. Data buffer unit 54 of the present embodiment of the present invention is shown in FIG. 7, having a two input ports and one output port design for the purpose of matching the first and second interpolators 44A, 44B, however, it can also be designed as a one input port or more than two input ports depending on the number of interpolators used. Moreover, a Data_Valid line might be required at each port to indicate data validation at both the input and output ends of data buffer unit 54. Then based on the output signal 45, the data circuit 48 is able to extract the digital data correctly from the input signal 36.

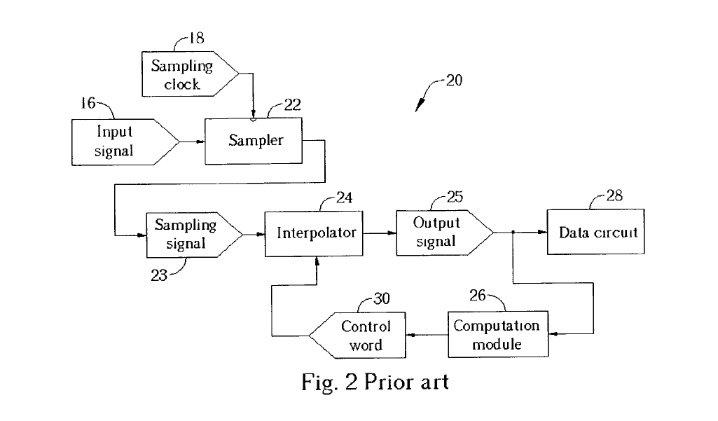

The most important difference between the present invention circuit 40 and the prior art comes from the operating process of weighted interpolation. In the prior art, shown in FIG. 2, an interpolator 24 calculates the amplitude of an output signal 25 corresponding to a data period, with the help of a control word 30, during each sampling period Tps. In the present invention, a plurality of interpolators (two interpolators are illustrated in FIG. 5 of the present embodiment) calculate a plurality of amplitudes of the output signal 45 corresponding to a plurality of data periods with a aid of a plurality of different control words (two control words are illustrated in FIG. 5 of the present embodiment) during each sampling period Ts. Using the output signal 45 as a feedback signal in the data recovery circuit 40, the first computation unit 50A and the second computation unit 50B of the computation module 46 generate a first control word 52A and a second control word 52B, respectively. During the same sampling period Ts, the first interpolator 44A generates an output signal with an amplitude corresponding to one data period according to the first control word 52A, and the second interpolator 44B generates a output signal with an amplitude corresponding to another data period according to the second control word 52B. The outputs of the interpolators are then stored in the data buffer unit 54 after being generated. After the buffering process by the data buffer unit 54, the data buffer unit 54 calculates the output signal 45 having an amplitude corresponding to two data periods in one sampling period according to two control words. The method of calculating the control words in both the first computation unit 50A and the second computation unit 50B is well known in the art.

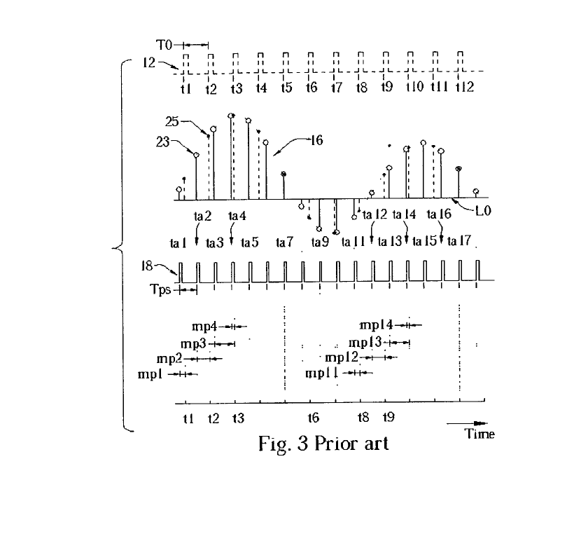

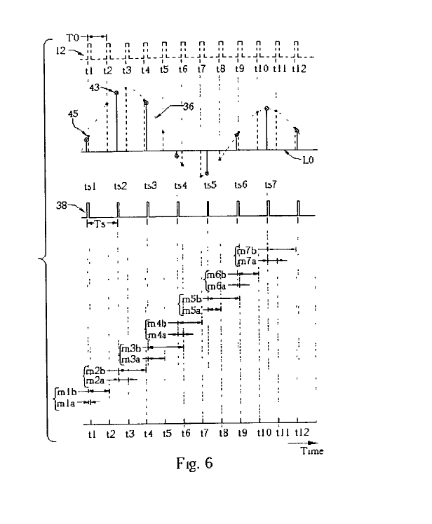

For a better understanding of the operation of the data recovery circuit 40 shown in FIG. 5 according to the present invention, waveform diagrams of the related signals are shown in FIG. 6, which has time along the abscissa. For comparison between the present invention and the prior art, the input signal 36 in FIG. 6 is assumed to be the same as the input signal 16 in FIG. 1 and FIG. 3. The waveform diagrams, from top to bottom, are the data clock 12, the input signal 36, and the sampling clock 38. The waveform of the input signal 36 is shown in FIG. 6 as a dotted curved line. Without the use of the data clock 12, the sampler 42 generates a sampling signal 43 by sampling the input signal 36 according to the triggering of sampling clock 38 with a sampling period of Ts.

The amplitude of the sampling signal 43 according to the input signal 36 at each sampling period, which are located at times ts1, ts2, ts3, etc is shown by a crossed circle with a solid line stretching to the abscissa in FIG. 6. As mentioned, the sampling frequency fs of the sampling clock 38 is lower than the frequency fd of the corresponding data clock 12. Consequently, the duration of a sampling period Ts is longer than that of a data period T0. In other words, a sampling period corresponds to more than one data period. For this situation, a computing process is designed to calculate a plurality of control words in each sampling period to estimate the phase difference, which is actually the time difference, between the sampling period and the corresponding plurality of data periods. As shown in FIG. 6, the computation module 46 calculates a first control word ml a and a second word m1b at time ts1 of one sampling period. The control words m1a and m1b are utilized to estimate the phase difference between the sampling period and the data periods at times t1 and t2. Based on the first control word m1a, the first interpolator 44A is able to calculate the amplitude of an output signal at time t1 using an interpolation process. Similarly, based on the second control word m1b, the second interpolator 44B is able to calculate an output signal at time t2 using an interpolation process. In the same way, the computation module 46 calculates a first control word m2a and a second control word m2b at time ts2 of another sampling period. The control words m2a and m2b are utilized to estimate the phase difference between the sampling period and the data periods at times t3 and t4. Corresponding to the sampling period at time ts5, a first control word m5a and a second control word m5b are utilized to estimate the phase difference between the sampling period and the data periods at times t8 and t9. Likewise, corresponding to the sampling period at time ts6, a first control word m6a and a second control word m6b are utilized to estimate the phase difference between the sampling period and the data periods at times t9 and t10. As shown in FIG. 6, both the control words m5b and m6a can be utilized to estimate the amplitude of the output signal 45 at time t9. In other words, the amplitude of the output signal 45 at time t9 can be estimated either from the calculation of the second interpolator 44B based on the control word m5b, or from the calculation of the first interpolator 44A based on the control word m6a. In this case, the data buffer unit 54 is utilized to select one of the interpolators to provide the amplitude of the output signal 45 at time t9. Therefore, according to the present invention, and based on a plurality of control words corresponding to a sampling period, a plurality of interpolators is able to interpolate the amplitude of the output signal 45 from the sampling signal 43 at each data period.

Even though a lower sampling frequency of the sampling clock 38 relative to the data clock 12 is used in the present invention, the output signal 45 can still be estimated precisely by the interpolation process performed on the sampling signal 43. Since a sampling period corresponds to more than one data period, a plurality of control words is calculated corresponding to a plurality of data periods and is utilized to estimate the amplitude of the output signal 45 at each sampling period. As shown in FIG. 6, the discrete output signal 45, shown by a solid circle with dashed line stretching to the abscissa, precisely generated by both the first interpolator 44A and the second interpolator 44B, is actually synchronized with the data clock 12. The digital data related to the input signal 36 can thus be extracted from the synchronized output signal 45 by the data circuit 48. The method, of calculating the output signals of the first interpolator 44A and the second interpolator 44B based on the sampling signal 43, the first control word 52A, and the second control word 52B, can be described by the following expressions, which are the formula for calculating the amplitudes of the output signal 45 at times t1 and t2.

$$\begin{matrix}Y ( t1 ) = {\sum }_{n = 1}^{N2} x ( ts1 - nTps ) W ( m1a + nTs ) & ( eq . 1 ) \\ Y ( t2 ) = {\sum }_{n = 1}^{N2} x ( ts1 - nTps ) W ( m1b + nTs ) & ( eq . 2 )\end{matrix}$$

Wherein Y(t1) is the amplitude of output signal 45 at time t1, Y(t2) is the amplitude of output signal 45 at time t2, W(˜) is a preset weighting function, and X(˜) is the amplitude of the sampling signal 43. N1 and N2 are integers that define the upper and lower limits of the summation. In eq. 1, the amplitude of output signal 45 at time t1 can be calculated with the aid of the first control word ml a, which is utilized to estimate the phase difference between the sampling period at time ts1 and the data period at time t1, by the summation of a product of a sampling signal 43 at time ts1, that is X(ts1), and a weighting function W(m1a), and a product of a sampling signal 43 at time ts2, that is X(ts1+Ts), and a weighting function W(m1a−Ts), and a product of a sampling signal 43 at time ts3, that is X(ts1+2Ts), and a weighting function W(m1a−2Ts), and so on. Therefore, the first interpolator 44A is able to calculate the amplitude of the output signal 45 at time t1 by eq. 1. Similarly, the phase difference between the sampling period at time ts1 and the data period at time t2 is estimated by the second control word m1b, and the second interpolator 44B is able to calculate the amplitude of output signal 45 at time t2 by eq. 2. Accordingly, based on the two control words generated in the same sampling period, the first and the second interpolators are able to estimate the amplitude of the output signal 45 corresponding to two data periods by eq. 1 and eq. 2. For this reason, even though the sampling signal 43 is not synchronized with the data clock 12, the output signal 45 generated by the first interpolator 44A and the second interpolator 44B is synchronized with data clock 12 as shown in FIG. 6. The digital data related to the input signal 36 can thus be extracted from the synchronized output signal 45 by data circuit 48. Although the above explanation is based on the sampling period at time ts1, those skilled in the art can easily discern on how to estimate the amplitude of the output signal 45 at other sampling periods. As shown in FIG. 6, according to the present invention, although a lower sampling frequency is utilized to generate the sampling signal 43, which means a lower sampling data density in the sampling signal 43, the amplitude of the output signal 45 corresponding to each data period can be precisely generated.

In summary, the present invention takes the advantage of the Nyquist theorem to reduce the sampling frequency to a value less than the frequency of the corresponding data period. A plurality of corresponding control words are estimated in one sampling period to represent a corresponding plurality of data periods in the same sampling period. Based on a plurality of control words in one sampling period, the amplitude of the output signal corresponding to a plurality of sampling periods can thus be estimated. As aforementioned, in the prior art, the amplitude of an output signal corresponding to one data period can be generated in one sampling period with one control word estimated in the same sampling period, meaning that the sampling frequency must not be lower than the frequency of corresponding data period.

In contrast to the prior art, the present invention is able to operate with a reduced sampling frequency. Since the present invention is achieved by digital logic circuits, it is easily integrated into the advanced digital systems of modern information networks. All the processes from circuit design and simulation to production are based on digital circuit technology. The present invention has a lower operating frequency without degradation of the sampling quality. This means that the side effects of high frequency operation such as electromagnetic interference and other related parasitic effects can be avoided. Furthermore, complex and expensive high frequency circuit designs are not required.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A data recovery method for recovering digital data from a corresponding input signal, the digital data being synchronized with a data clock, the data clock comprising a plurality of data periods, amplitude of the input signal during each data period of the data clock representing the digital data;
the data recovery method comprising:
selecting a sampling clock with a predetermined sampling frequency, the sampling clock comprising a plurality of sampling periods;
calculating at least a control word during each sampling period, each control word being used for estimating a phase error between the sampling period and the corresponding data period;
calculating an original amplitude of said input signal within each data period of the data clock according to the corresponding control word and amplitude of said input signal during each sampling period of the sampling clock for recovering the digital data; and
storing said original amplitude of said input signal of the corresponding control word;
wherein the sampling frequency, in a frequency domain, is higher than a maximum frequency of the input signal bandwidth and is lower than a frequency of the data clock.

2. The data recovery method of claim 1 wherein said control word is calculated according to the amplitude of said input signal during the corresponding sampling period.

3. The data recovery method of claim 1 wherein the input signal is outputted from an optical disk storage device, such as a compact disk (CD) player, CD-ROM or digital versatile disc (DVD) device.

4. The data recovery method of claim 1 further comprising the step of using the recovered digital data to adjust the control word further.

5. The data recovery method of claim 1 wherein a weighted interpolation algorithm is used for calculating the original amplitude of the input signal during each data period according to the corresponding control words and amplitude of the input signal during each sampling period.

6. A data recovery circuit for recovering digital data from a corresponding input signal, the digital data being synchronized with a data clock, the data clock comprising a plurality of data periods, amplitude of the input signal during each data period of the data clock representing the digital data;
the data recovery circuit comprising:
a sampler for measuring amplitude of said input signal during each sampling period, a duration of each sampling period being fixed and being related to a sampling frequency;
a computation module for calculating at least a control word during each sampling period, each control word being used for estimating a phase error between said sampling period and the corresponding data period; and
at least an interpolator, each interpolator respectively handling each control word during one sampling period for calculating each amplitude of said input signal during each data period according to both the corresponding control word and an output of the sampler in order to recover said digital data;
wherein said sampling frequency, in a frequency domain, is higher than a maximum frequency of the input signal bandwidth and is lower than a frequency of said data clock.

7. The data recovery circuit of claim 6 further comprises a storage medium connected to said interpolator to receive said amplitude of said input signal within each of said data clock period and to generate the recovered digital data.

8. The data recovery circuit of claim 6 wherein the control word is calculated according to the amplitude of said input signal during the corresponding sampling period.

9. The data recovery circuit of claim 6 wherein the computation module uses the recovered digital data to adjust the control word further.

10. The data recovery circuit of claim 6 wherein said interpolator uses a weighted interpolation algorithm for calculating the original amplitude of the input signal during each data period according to the corresponding control words and amplitude of the input signal during each sampling period.

11. A data recovery circuit for recovering digital data with a relative low sampling frequency, the data recovery circuit comprising:
a sampling device for sampling an analog input signal to generate a sequence of discrete time sample values that represent amplitudes of said input signal during each sampling period, a duration of each sampling period being fixed and being inversely related to said sampling frequency;
a computation module responsive to an output signal for calculating a plurality of control words during each sampling period, said control words being used for estimating a phase error between said sampling period and a data clock period; and
a plurality of interpolators, each interpolatorrespectively handling each of said control words during one sampling period together with each of said discrete time sample values for calculating an amplitude of said input signal within each of said data clock period in order to recover said digital data.

12. The data recovery circuit of claim 11 further comprises a storage medium connected to said plurality of interpolators to receive said amplitude of said input signal within each of said data clock period and to generate said output signal.

13. The data recovery circuit of claim 11 wherein said computation module comprises a plurality of computation units for generating said plurality of control words.

14. The data recovery circuit of claim 11 wherein said sampling frequency, in a frequency domain, is higher than a maximum frequency of the input signal bandwidth and is lower than a frequency of said data clock.

15. The data recovery circuit of claim 11 wherein said control word is calculated according to the amplitude of said input signal during the corresponding sampling period.

16. The data recovery circuit of claim 11 wherein said interpolator uses a weighted interpolation algorithm for calculating the original amplitude of said input signal during each data period according to the corresponding control word and amplitude of the input signal during each sampling period.

17. A data recovery circuit for recovering digital data with a relative low sampling frequency, the data recovery circuit comprising:
a sampling device for sampling an analog input signal to generate a sequence of discrete time sample values that represent amplitudes of said input signal during each sampling period, a duration of each sampling period being fixed and being inversely related to said sampling frequency;
a computation module responsive to a recovered digital data for calculating a plurality of control words during each sampling period, said control words being used for estimating a phase error between said sampling period and a data clock period;
a plurality of interpolators, each interpolator respectively handling each of said control words during one sampling period together with each of said discrete time sample values for calculating an amplitude of said input signal within each of said data clock period in order to recover said digital data; and
a data buffer connected to said plurality of interpolators to receive said amplitude of said input signal within each of said data clock period and to generate said recovered digital data;
wherein said sampling frequency, in a frequency domain, is higher than a maximum frequency of the input signal bandwidth and is lower than a frequency of said data clock.

18. The data recovery circuit of claim 17 wherein said computation module comprises a plurality of computation units for generating said plurality of control words.

19. The data recovery circuit of claim 17 wherein said control word is calculated according to the amplitude of said input signal during the corresponding sampling period.

20. The data recovery circuit of claim 17 wherein said interpolator uses a weighted interpolation algorithm for calculating the original amplitude of said input signal during each data period according to the corresponding control word and amplitude of the input signal during each sampling period.
